(19) United States
(12) Patent Application Publication
(10) Pub. No.: US 2013/0164772 A1
(43) Pub. Date: Jun. 27, 2013

(54) METHODS FOR THE EXTRACTION AND IDENTIFICATION OF ANTIPERSPIRANT SALT PLUGS

(71) Applicants: Elizabeth A. Moyer, Phoenix, AZ (US); Diana G. Hassenbein, Phoenix, AZ (US); Louise Aust, Phoenix, AZ (US); Leslie K. Lockhart, Phoenix, AZ (US)

(72) Inventors: Elizabeth A. Moyer, Phoenix, AZ (US); Diana G. Hassenbein, Phoenix, AZ (US); Louise Aust, Phoenix, AZ (US); Leslie K. Lockhart, Phoenix, AZ (US)

(21) Appl. No.: 13/333,412

(22) Filed: Dec. 21, 2011

(51) Int. Cl. G01N 21/78

(52) U.S. Cl. 435/29

(57) ABSTRACT

Methods for the extraction and identification of antiperspirant salt plugs are provided. In accordance with an embodiment, a method for the extraction and identification of antiperspirant salt plugs comprises applying to skin an antiperspirant product and applying to the skin a transparent slide having a glue disposed thereon, wherein the glue is placed in contact with an area of the skin having the antiperspirant product applied thereto. The glue is allowed to cure to the area of the skin. The transparent slide and a sample coupled to the transparent slide are removed. The sample comprises the cured glue and first skin layers from the area of the skin. A stain sensitive to aluminum is applied to the sample. The sample is differentiated and the sample is allowed to dry.

### TECHNICAL FIELD

The present invention generally relates to antiperspirants, and more particularly relates to methods for the extraction and identification of antiperspirant salt plugs from glands of the skin.

### BACKGROUND

Antiperspirants are popular personal care products used to prevent or eliminate perspiration and body odor caused by perspiration. Antiperspirants are desired by a large majority of the population because of the presence of active antiperspirant compounds that minimize or prevent the secretion of perspiration by blocking or plugging ducts of sweat-secreting glands, such as those located at the axilla. Antiperspirants typically comprise an active antiperspirant compound in a carrier that permits the antiperspirant product to be applied to the skin by swiping or rubbing it across the skin, typically of the axilla. Upon application, the carrier evaporates, releasing the active antiperspirant compound from the antiperspirant product to coagulate with sweat duct proteins to form plugs in the sweat ducts. The effectiveness of an antiperspirant depends on factors such as how many antiperspirant salt plugs are formed in the sweat ducts, how deep the plugs form in the ducts, and how many plugs remain after certain activities, such as sweating, swimming, showering, or shaving. Thus, it would be desirable to be able to extract antiperspirant salt plugs from the skin and identify the plugs to permit in vivo research regarding the number of antiperspirant salt plugs formed after a predetermined number of applications, product form comparisons (e.g., stick antiperspirants compared to roll-on antiperspirants) regarding plug depth and frequency, and environmental effects on the number and depth of plugs (e.g., effects of sweating, swimming, etc.).

Accordingly, it is desirable to provide methods for the extraction of antiperspirant salt plugs from the skin. In addition, it is desirable to provide methods for the extraction and identification of antiperspirant salt plugs obtained from the skin. Furthermore, other desirable features and characteristics of the present invention will become apparent from the subsequent detailed description of the invention and the appended claims, taken in conjunction with the accompanying drawings and this background of the invention.

### BRIEF SUMMARY

Methods for the extraction and identification of antiperspirant salt plugs are provided. In accordance with an exemplary embodiment, a method for the extraction and identification of antiperspirant salt plugs comprises applying to skin an antiperspirant product and applying to the skin a transparent slide having a glue disposed thereon. The glue is placed in contact with an area of the skin having the antiperspirant product applied thereto. The glue is allowed to cure to the area of the skin. The transparent slide and a sample coupled to the transparent slide are removed, the sample comprising the cured glue and first skin layers from the area of the skin. A stain sensitive to aluminum is applied to the sample, the sample is differentiated, and the sample is allowed to dry.

In another embodiment, a method for the extraction of antiperspirant salt plugs comprises applying antiperspirant product to skin and removing extraneous matter from the skin. A first glue is placed on a first transparent slide and the first transparent slide is applied to the skin with the first glue in contact with an area of the skin. The first glue is caused to cure to the area of the skin and the first transparent slide with a first sample comprising the first glue and first skin layers is removed from a surface of the area of the skin. A second glue is placed on a second transparent slide and the second transparent slide is placed on the area of the skin with the second glue in contact with the area of the skin. The second glue is allowed to cure to the skin and the second transparent slide with a second sample comprising the second glue and second skin layers from the area of the skin is removed. The second skin layers are deeper than the first skin layers from the surface of the area of the skin.

In accordance with a further exemplary embodiment, a method for staining a sample containing antiperspirant salt plugs obtained from human skin comprises obtaining a sample of skin from a human, wherein the skin is adhered to a transparent slide by a cyanoacrylate glue, and wherein the skin contains aluminum salt plugs. A stain sensitive to aluminum is applied to the sample and excess stain is removed from the sample. The sample is differentiated and caused to dry.

### BRIEF DESCRIPTION OF THE DRAWINGS

The present invention will hereinafter be described in conjunction with the following drawing figures, wherein like numerals denote like elements, and wherein:

FIG. 1 is a graph illustrating the average number of aluminum salt plugs from a first extraction and a second extraction, in accordance with an exemplary embodiment, from 10 subjects having used eight applications of an antiperspirant and from 10 subjects having used eight applications of a placebo; and

FIG. 2 is a graph illustrating the average number of aluminum salt plugs identified from a first extraction, in accordance with an exemplary embodiment, from 6 subjects having used 3 and 10 subjects having used 8 applications of an antiperspirant and from a first extraction, in accordance with an exemplary embodiment, from 6 subjects having used 3 and 10 subjects having used 8 applications of a placebo.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Various embodiments contemplated herein are directed to methods for extracting antiperspirant salt plugs from skin, such as the axilla, the forearm, or the back of a human subject, and identifying those plugs for such purposes as, for example, studying antiperspirant performance and efficacy. Because antiperspirant salt plugs may form relatively deeply within sweat ducts of the skin, various embodiments contemplated herein utilize at least two extractions of plugs from the same area of the skin. In this manner, by analyzing the plugs from both extractions, a more accurate assessment of the number of plugs formed can be obtained. In addition, an assessment of the depth to which the plugs form can also be achieved.

In an exemplary embodiment, a method for extracting antiperspirant salt plugs from human skin begins by applying an antiperspirant product to the skin. For purposes of illustration, the method will be described with reference to skin of the axilla of a human subject. However, it will be appreciated that the methods contemplated herein are not so limited and the methods can be used for extracting antiperspirant salt plugs from the forearm, the back, or other similar area of human skin. The antiperspirant product comprises an active antiperspirant compound containing an aluminum salt that reduces perspiration by diffusing into the sweat ducts of apocrine glands (glands that produce sweat responsible for body odor) and eccrine glands (glands that produce most of the body's perspiration) and solubilize in the sweat ducts, where the aluminum salt combines with proteins to form an amorphous aluminum hydroxide agglomerate, plugging the sweat ducts so perspiration cannot diffuse to the skin surface. Particular aluminum-containing salts or materials include aluminum halides, aluminum chiorohydrates, and aluminum hydroxyhalides. Exemplary aluminum salts include those having the general formula Al₂(OH)ₐCl_{b} x (H₂O), wherein a is from 2 to about 5; a and b total to about 6; x is from 1 to about 6; and wherein a, b, and x may have non-integer values. Examples of active antiperspirant aluminum compounds suitable for use in the various embodiments contemplated herein include aluminum dichlorohydrate, aluminum-zirconium octachlorohydrate, aluminum sesquichlorohydrate, aluminum chlorohydrex propylene glycol complex, aluminum dichlorohydrex propylene glycol complex, aluminum sesquichlorohydrex propylene glycol complex, aluminum chlorohydrex polyethylene glycol complex, aluminum dichlorohydrex polyethylene glycol complex, aluminum sesquichlorohydrex polyethylene glycol complex, aluminum-zirconium trichlorohydrate, aluminum zirconium tetrachlorohydrate, aluminum zirconium pentachlorohydrate, aluminum zirconium octachlorohydrate, aluminum zirconium trichlorohydrex glycine complex, aluminum zirconium tetrachlorohydrex glycine complex, aluminum zirconium pentachlorohydrex glycine complex, aluminum zirconium octachlorohydrex glycine complex, aluminum chloride, aluminum sulfate buffered, and the like, and mixtures thereof.

In an exemplary embodiment, the axilla is cleaned to remove extraneous matter on the test site, including excess antiperspirant on the axilla skin surface. In this manner, surface aluminum, which otherwise may interfere with staining of slides, to be discussed below, is substantially and, for example, completely removed. In an embodiment, the axilla is cleaned at least 6, for example 12, for example 24, hours after the antiperspirant is applied to the axilla to permit the antiperspirant adequate opportunity to migrate into the sweat ducts. The axilla may be cleaned with ethanol, such as, for example, 95% ethanol, 70% isopropanol, water, soap solution, or the like. The axilla is allowed to dry, such as by permitting the cleaning solution to evaporate or by applying air to the wet area. The human subject is positioned with their arm extended beyond the head and the hand behind the head so that the skin of the axilla is flat and taut. The exterior of the extraction site then can be marked.

An adhesive or glue (hereinafter collectively “a glue”) is deposited on a transparent slide, for example, a glass or otherwise transparent microscope slide and distributed evenly thereon. The glue is of a type that is fast curing, that is, it sets, cures or otherwise dries within a matter of seconds or minutes, such as 30 seconds to 2 minutes, is adherent to glass and to human skin and/or to antiperspirant salt plugs, does not degrade over time once dried on the slide, and is capable of pulling several layers of skin, for example, 4 to 8 layers, for example, 6 layers, of skin from the axilla once dried and the microscope slide is removed from the axilla. In an exemplary embodiment, the glue is a cyanoacrylate adhesive.

The side of the slide with the glue thereon is placed against the skin of the axilla within the marked exterior. In an exemplary embodiment, the slide is placed against the skin before the glue has a chance to cure or set on the slide, such as, for example, within 15 seconds or less of application of the glue to the slide. The slide is allowed to remain on the skin for a sufficient amount of time for the glue to cure or set to the skin, such as, for example, about 90 seconds or more or less depending on the particular glue used. Once the glue has cured or set, the slide is removed from the axilla. In an embodiment, the slide is removed from the axilla by slowly pulling the slide from the skin in a rocking manner. As the slide is removed, approximately the first layers of the skin of the axilla, for example, the first 4 to 8 layers, for example, the first 6 layers of skin, adhere to the glue, thus causing the layers of skin and antiperspirant salt plugs formed within sweat ducts at these layers of skin to be removed from the axilla.

After removing the slide from the axilla, a second extraction is performed in accordance with an exemplary embodiment. A second glue is deposited on a second transparent slide, for example, a glass or otherwise transparent microscope slide and distributed evenly thereon. The glue is of a type similar to that used in the first extraction, that is, fast drying, adherent to glass and to human skin and/or to antiperspirant salt plugs, stable over time once dried on the slide, and capable of pulling skin layers, for example, 4 to 8 layers, for example, 6 layers, of skin from the axilla once dried and the microscope slide is removed from the axilla. In an exemplary embodiment, the second glue is a cyanoacrylate adhesive. The first glue and the second glue can be the same glue or can be different glues.

The side of the second slide with the glue thereon is placed against the skin of the axilla within the marked exterior and at approximately the same area where the first slide was placed on the axilla. In an exemplary embodiment, the second slide is placed against the skin before the glue has a chance to cure or set on the slide, such as, for example, within 15 seconds or less of application of the glue to the slide. The second slide is allowed to remain on the skin for an amount of time sufficient for the glue to cure or set to the skin, such as, for example, about 90 seconds or more or less depending on the particular glue used. Once the glue has cured or set, the second slide is removed from the axilla. Again, the second slide can be removed from the axilla by slowly pulling the slide from the skin in a rocking manner. As the second slide is removed, another set of skin layers, for example, approximately the next 4 to 8 layers of the skin of the axilla, that were below the first layers, for example, the next 6 layers of skin, adhere to the glue, thus causing the layers of skin and antiperspirant salt plugs formed within sweat ducts at these layers of skin to be removed from the axilla. Accordingly, antiperspirant salt plugs formed deeper in the skin may be retrieved in this second sample.

Once the first skin sample is extracted with the first slide and optionally the second skin sample is extracted with the second slide, a method for identification of antiperspirant salt plugs in the sample(s) may be utilized. The method includes applying to one or both slides a stain that is sensitive to aluminum. Examples of stains sensitive to aluminum include hematoxylin and 0.5% phloxine. In an exemplary embodiment, the stain is about 5 to about 10%, such as 1% aqueous acid solochrome azurine solution (also known as C.I. 43830, Chrome Azurol B, Eriochrome Azurol B, Mordant blue, and Chromeazurol B). The stain can be applied to the sample and the slide by any suitable method so that the aluminum in the sample is contacted by enough stain to be identifiable when the sample is examined under a microscope but that does not damage the integrity of the sample. For example, the slides can be immersed in the stain(s) or the sample(s) can be irrigated with a sufficient amount of stain(s) so that the sample is covered in the stain(s). The sample is exposed to the stain for a contact time dependent on the stain used. In an exemplary embodiment, the slides are immersed in 1% aqueous acid solochrome azurine solution for about 10 minutes. The stain then is removed from the slide, or the slide is removed from the stain as the case may be. In an exemplary embodiment, the slide and sample is subjected to water to remove excess stain therefrom. For example, the slide and sample may be dipped in water or may be irrigated with water to remove the excess stain.

Next, the sample is differentiated to stop the staining process and accentuate the aluminum salt plugs. In an exemplary embodiment, the sample is differentiated in alcohol in a manner such that the alcohol is kept moving past the sample. For example, the slide and sample can be dipped in and out of the alcohol. The sample is exposed to a strength of alcohol for an amount of time sufficient to differentiate the sample but not to a strength and for a time that results in damage to the integrity of the sample. In an embodiment, the slide and sample are immersed in a 50% ethanol alcohol solution for about 30 to 60 seconds. The alcohol solution then is removed from the slide, or the slide is removed from the alcohol solution as the case may be. In an exemplary embodiment, the slide and sample is subjected to water to remove excess alcohol solution therefrom. For example, the slide and sample may be dipped in water or may be irrigated with water to remove the excess alcohol solution. The sample and slide are then allowed to dry. For example, the sample and slide may be permitted to air dry or air may be blown gently over the sample and slide to cause the sample and slide to dry.

Once dry, the slide and sample adhered thereon can be viewed under a light microscope. Aluminum salt plugs will appear stained blue to purple and any comedones and hair in the sample will appear stained red to brown. The sample from the first extraction and the sample from the second extraction can be analyzed to evaluate the effectiveness of the antiperspirant product. For example, the number of aluminum salt plugs from either or both of the samples can be compared to extractions obtained from axilla to which a placebo product was applied, that is, a product comprising no aluminum salt. Alternatively, or in addition, the sample from the first extraction can be compared to the sample from the second extraction to compare the number of salt plugs formed at the first layers of skin of the axilla and the number of salt plugs formed at deeper layers of skin of the axilla. The number of salt plugs formed after a number of applications, or the number of salt plugs that remain after showering, swimming, exercising, or the like also can be evaluated. Any number of other factors affecting the formation or maintenance of aluminum salt plugs can also be observed using the methods herein described.

The following are observations made using exemplary embodiments of the methods contemplated herein. The observations are provided for illustration purposes only and are not meant to limit the various embodiments of the methods in any way.

### EXAMPLE

This study followed a paired comparison test design. During the study, Test Article A (an “invisible” solid antiperspirant containing an aluminum salt) was directly compared to Test Article B (an “invisible” solid placebo containing no aluminum salt). As used herein, the term “invisible” refers to a solid antiperspirant or placebo that deposited virtually no white film onto the skin. Within each pair, Test Articles A and B were randomly assigned to either the right or left axilla of 10 human subjects. The study included a 17 day conditioning period during which no antiperspirant products were used by the subjects. Following the conditioning period, the subjects were given a Test Article A and a Test Article B, told which to use on the right and left axilla, and then were subjected to the method of extraction according to an exemplary embodiment after the third and eighth applications of the Test Articles.

After the third and eighth applications of the Test Articles, both axillas of each subject were wiped with 95% ethanol and the axillas were allowed to air dry for approximately 3 to 5 minutes. The subjects positioned themselves with their arms raised and resting behind the head so the skin of the axilla was as flat and taut as possible. The exterior of the extraction site was marked to indicate the sample area of each axilla. The test site area was approximately 6 centimeters² (cm²). For each axilla, approximately 2 drops of cyanoacrylate adhesive was deposited on a glass microscope glass slide. The slide was rocked back and forth to evenly distribute the adhesive on the slide. Each slide was applied to the marked test site within 15 seconds of the adhesive application to the slide. The adhesive was allowed to cure for approximately 90 seconds and then was pulled slowly away from the skin in a rocking manner. For each axilla, approximately 2 drops of the cyanoacrylate adhesive was deposited on a second microscope glass slide. Again, each slide was applied to the marked test site within 15 seconds of the adhesive application to the slide. The adhesive was allowed to cure for approximately 90 seconds and then was pulled slowly away from the skin in a rocking manner. The slides were marked to indicate the subject, the numbers of antiperspirant applications, and whether it was a first extraction or a second extraction.

The slides and samples disposed thereon were then stained. Each slide was immersed in a 1% aqueous acid solution of solochrome azurine for approximately 10 minutes. The slides were removed from the solution and briefly dipped in water to remove excess stain from the sample. The samples were differentiated in a 50% ethanol alcohol solution by dipping the slides into and out of the solution for 30 to 60 seconds. The samples were washed in water to remove the alcohol solution. The samples were allowed to air dry and then examined under a light microscope. Aluminum salt plugs were stained a blue to purple color while any comedones and hair were stained a red to brown color.

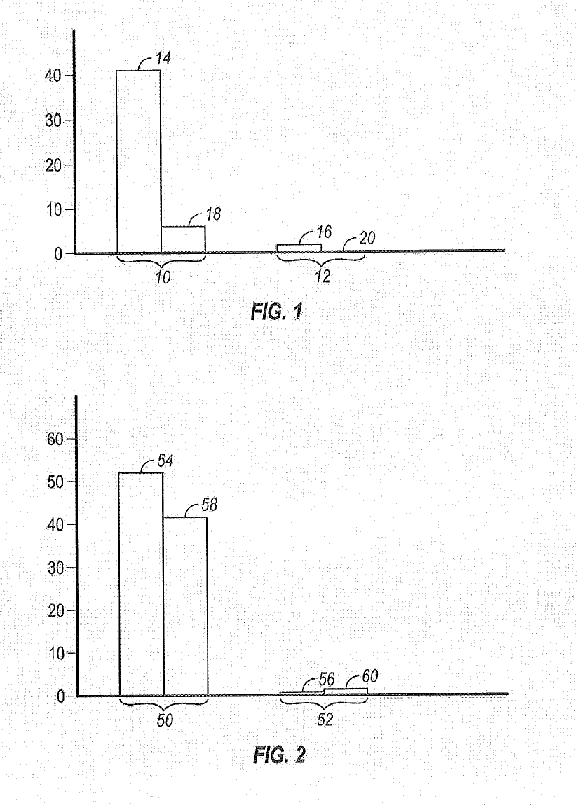

FIG. 1 illustrates the average number of aluminum salt plugs in a 6 cm² area from a first extraction and in a 6 cm² area from a second extraction from 10 subjects having used eight applications of an antiperspirant 10 and from 10 subjects having used eight applications of a placebo 12. The first set of results 14 and 16 indicate the number of plugs after the first extraction and the second set of results 18 and 20 indicate the number of plugs after the second extraction. A statistically significant difference is illustrated between the number of plugs identified for the antiperspirant and for the placebo for both the first extraction and the second extraction. An average of 41 plugs were identified for the first extractions from axillas to which antiperspirant was applied compared to an average of 0.4 plugs for the first extractions from axillas to which a placebo was applied, with a p-value of 0.01. An average of 6.1 plugs were identified for the second extractions from axillas to which antiperspirant was applied compared to no plugs for the second extractions from axillas to which the placebo was applied, with a p-value of 0.01.

FIG. 2 illustrates the average number of aluminum salt plugs identified in a 6 cm² area from a first extraction from an antiperspirant treated area 50 and in a 6 cm² area from a first extraction from a placebo treated area 52. The first set of results 54 and 56 indicate the number of plugs identified after three applications (6 subjects) of the Test Article (either the antiperspirant or the placebo) and the second set of results 58 and 60 indicate the number of plugs identified after eight applications (10 subjects) of the Test Article (either the antiperspirant or the placebo). A statistically significant difference is illustrated between the number of plugs identified from first extractions for the antiperspirant and for the placebo after both 3 applications and 8 applications. An average of about 52.5 antiperspirant salt plugs were identified from first extractions from subjects who applied antiperspirant three times compared to an average of about 0.3 antiperspirant salt plugs identified from first extractions from subjects who applied a placebo three times. The p-value was 0.04. An average of about 41 antiperspirant salt plugs were identified from first extractions from subjects who applied antiperspirant eight times compared to an average of about 0.4 antiperspirant salt plugs identified from first extractions from subjects who applied a placebo eight times. The p-value was 0.01. In contrast, there was no statistical difference between an average of 52.5 antiperspirant salt plugs identified from first extractions from subjects who applied antiperspirant three times compared to an average of 41 antiperspirant salt plugs identified from first extractions from subjects who applied the antiperspirant eight times. The p-value was 0.32.

Accordingly, various embodiments directed to methods for extracting antiperspirant salt plugs from the axilla and identifying those plugs for such purposes as, for example, studying antiperspirant performance and efficacy have been provided. Because antiperspirant salt plugs may form relatively deeply within sweat ducts of the axilla, various embodiments contemplated herein utilize at least two extractions of plugs from the same area of the axilla. In this manner, by analyzing the plugs from both extractions, a more accurate assessment of the number of plugs formed can be obtained. In addition, an assessment of the depth to which the plugs form can also be achieved.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A method for the extraction and identification of antiperspirant salt plugs, the method comprising the steps of:
applying to skin an antiperspirant product;
applying to the skin a transparent slide having a glue disposed thereon, wherein the glue is placed in contact with an area of the skin having the antiperspirant product applied thereto, wherein the glue is in contact with the skin for a predetermined time period;
removing the transparent slide and a sample coupled to the transparent slide after the predetermined time period, the sample comprising the cured glue and first skin layers from the area of the skin;
applying a stain sensitive to aluminum to the sample;
differentiating the sample such that aluminum in the sample visually appear a different color from a non-aluminum portion of the sample;
allowing the sample to dry; and
identifying and quantifying areas of the different color on the sample, wherein the presence of the areas of the different color indicate the presence of aluminum salt plugs.

2. The method of claim 1, wherein the step of applying to skin an antiperspirant product comprises applying antiperspirant product to skin of a human axilla.

3. The method of claim 1, wherein the step of differentiating comprises differentiating with an alcohol and further comprising removing the alcohol after differentiating.

4. The method of claim 3, wherein the step of differentiating with an alcohol comprises differentiating with a 50% ethanol alcohol solution.

5. The method of claim 1, wherein applying to the skin the transparent slide comprises applying to the skin the transparent slide having a cyanoacrylate glue disposed thereon.

6. The method of claim 1, wherein applying the stain comprises applying a 1% aqueous acid solochrome azurine solution.

7. The method of claim 1, wherein applying the stain comprises applying hematoxylin, or phloxine.

8. The method of claim 1, further comprising cleaning the skin of extraneous matter after applying to the skin an antiperspirant product and before applying to the skin the transparent slide.

9. The method of claim 8, wherein cleaning the skin comprises cleaning the skin with 95% ethanol.

10. The method of claim 1, wherein applying the transparent slide is performed approximately 24 hours after applying the antiperspirant product.

11. The method of claim 1, further comprising:
applying to the skin a second transparent slide having a second glue disposed thereon, wherein the second glue is placed in contact with the area of the skin, wherein the glue is in contact with the skin for a second predetermined time period;
removing the second transparent slide and a second sample coupled to the second transparent slide after the second predetermined time period, the second sample comprising a cured second glue and second skin layers from the area of the skin, wherein the second skin layers were beneath the first skin layers before removing the transparent slide and the sample.

12. A method for the extraction of antiperspirant salt plugs, the method comprising the steps of:
applying antiperspirant product to skin;
removing extraneous matter from the skin;
placing a first glue on a first transparent slide;
applying the first transparent slide to the skin with the first glue in contact with an the area of the skin;
leaving the first glue in contact with the area of the skin for a predetermined time period;
after the predetermined time period, removing the first transparent slide with a first sample comprising the first glue and first skin layers from a surface of the area of the skin;
placing a second glue on a second transparent slide;
applying the second transparent slide on the area of the skin with the second glue in contact with the area of the skin, wherein the second glue is in contact with the skin for a second predetermined time period;
after the second predetermined time period, removing the second transparent slide with a second sample comprising the second glue and second skin layers from the area of the skin, the second skin layers deeper than the first skin layers from the surface of the area of the skin;
staining the first sample and the second sample such that aluminum in the first sample and the second sample appear a different color than a non-aluminum portion of the first sample and a non-aluminum portion of the second sample; and
identifying and quantifying areas of the different color on the first sample and on the second sample, wherein the presence of the areas of the different color indicate the presence of aluminum salt plugs.

13. The method of claim 12, wherein removing extraneous matter comprises removing extraneous matter using a 95% ethanol solution.

14. The method of claim 12, wherein placing the first glue comprises placing a cyanoacrylate glue.

15. The method of claim 12, wherein placing the second glue comprises placing a cyanoacrylate glue.

16. The method of claim 12, wherein placing the first glue and placing the second glue comprising placing the same glue.

17. The method of claim 12, wherein removing the first transparent slide comprises removing the first transparent slide with the first sample comprising layers of skin from a surface of the area of the skin.

18. The method of claim 17, wherein removing the second transparent slide comprises removing the second transparent slide with the second sample comprising layers of skin that were beneath the layers of skin of the surface of the area of the skin before removing the first transparent slide.

19. The method of claim 12, wherein applying the antiperspirant product is performed about 24 hours before removing extraneous matter.

20. A method for staining a sample containing antiperspirant salt plugs obtained from human skin, the method comprising the steps of:
obtaining a sample of skin from a human, wherein the skin is adhered to a transparent slide by a cyanoacrylate glue, and wherein the skin contains aluminum salt plugs;
applying a stain sensitive to aluminum to the sample;
removing excess stain from the sample;
differentiating the sample such that the aluminum in the sample visually appear a different color from non-aluminum portions of the sample; and
allowing the sample to dry.
